(19) United States
(12) Patent Application Publication
(10) Pub. No.: US 2019/0039692 A1
(43) Pub. Date: Feb. 7, 2019

(54) FLEXIBLE COMPLIANT LINE FOR PROVIDING A LINKAGE BETWEEN A FIRST STRUCTURE AND A SECOND STRUCTURE

(71) Applicant: TEQNIQA SYSTEMS LTD, Lavister (GB)

(72) Inventors: Peter Cronin GORDON, Liverpool (GB); David NEWSAM, Farndon, Chester (GB)

(21) Appl. No.: 16/078,592

(22) PCT Filed: Feb. 14, 2017
(86) PCT No.: PCT/GB2017/050382

§ 371 Date: Aug. 21, 2018

(30) Foreign Application Priority Data
Feb. 22, 2016 (GB) 1603035.5

(51) Int. Cl. B63B 21/20; B63B 21/50; F15B 1/02; F15B 1/08; F15B 15/10; D04C 1/12; D07B 1/12

(52) U.S. Cl. CPC B63B 21/20; B63B 21/502; F15B 1/021; F15B 1/08; B63B 35/44; D04C 1/12; D07B 1/12; B63B 2021/203; F15B 15/103

(57) ABSTRACT

An elongate, flexible line for providing a linkage between a first structure and a second structure. The line may be a mooring line. It has a braided tubular sheath, the sheath being able to change reversibly and repeatedly in length and its braided structure being such that an increase in sheath length is accompanied by a lateral dimensional decrease. Within the sheath is an impervious flexible bladder. The bladder defines a fluid-containing internal chamber which is acted on by the sheath so that the volume of the chamber varies with the sheath length. A pressure source arranged to pressurise the chamber. A restricted passage communicates with the chamber.

The pressurised bladder urges the sheath to expand laterally and to contract. An increase in sheath extension causes fluid to be exhausted from the chamber through the restriction, increasing chamber pressure and providing a damping force opposed to the sheath's extension.

The present invention relates to an elongate, flexible line for providing a compliant linkage between a first structure and a second structure. It can be employed in mooring lines for floating structures but the invention is not limited to this application alone.

Although the invention has a wide range of applications, its use in relation to mooring lines will be explained first of all. Mooring lines are used to tether floating structures of many different types including boats, ships, buoys, rigs for hydrocarbon extraction such as oil rigs, and energy generating devices such as wave energy devices or floating wind turbines. Mooring lines typically serve to tether the floating structure to some fixed structure, which could be a quay or pontoon, or may be the sea bed. Mooring lines are subject to variable loads due to motion of the tethered floating structure when it is subject to waves, wind, tidal flow and so on. They may also need to accommodate changes of height of the floating structure with the tide.

One challenge associated with moorings at sea is that heavy seas and large waves cause violent motion of even large floating structures, placing potentially destructive loads on their moorings.

Mooring lines used for boats and ships are often slack enough to accommodate both tidal sea level variation and movement caused by waves, but slack moorings permit movement of the moored structure away from its station, which is not acceptable in all cases.

In the case of moored, floating wave energy devices, for example, it is important that the moorings should constrain motion of parts of the device under normal conditions—such constraint is necessary to the proper functioning of energy generating devices. Forces exerted by waves must be reacted through the moorings for the generating device to function. But in heavy seas the devices need to be able to move more freely, e.g. to rise and fall along with large waves, in order to avoid damage.

In the case of floating platforms supporting wind turbines, it is important for the sake of efficiency to control the direction along which the platform faces, so that the turbine can be reliably faced into wind. It is also in some cases desirable for the moorings to reduce pitch and roll of the platform. To do this the mooring lines need to be kept under tension. But again, non-compliant moorings which prevent the platform from moving along with the surrounding body of water could suffer catastrophic loads in storm conditions, and could also contribute to damage to the platform or turbine.

It is known to incorporate compliance into moorings. For example GB2053303 describes a set of elastic mooring lines being used to secure a wave energy device. Compliance—in this case due to elasticity of the mooring line itself—allows the line to extend under transient loading and hence to reduce the peak loads created by violent motion of the device. Elastic lines are able to provide compliance but are not able to provide damping.

Mechanical shock absorbing arrangements that provide both compliance and damping are of course well known, often using a pre-stressed spring to provide a restoring force which varies with extension, and a hydraulic piston/cylinder arrangement to provide a damping force that varies with the rate of change of extension (that is, with speed). Incorporation of conventional mechanical/hydraulic spring-and-damper type devices in mooring lines is unattractive from various points of view. The size, cost and complexity of suitable devices—in the context of large platforms rising and falling through several metres and generating large line loads—would be considerable. Also it is often desirable for moorings to survive long design lifetimes (of the order of decades) with little or no maintenance despite the hostile environment experienced close to the water surface or beneath it. In this respect too, mechanical devices of the known piston/cylinder type are thought not to be an optimal solution.

EP0071406 describes a mooring line which may be used to moor a buoyant wave energy device and which has a tube made of vulcanised rubber into which are incorporated helically wound glass fibres. When subject to a tensile load, the rubber tube extends but its volume decreases, acting upon either gas or liquid within the tube. In one embodiment the rubber tube is filled with liquid which is pressurised by a hydro-pneumatic accumulator. Changes of tube length cause flow of fluid from the tube to the accumulator, or vice versa and the arrangement is said to provide a “stiff end-cushion effect at large extensions” when a piston of the accumulator moves far enough to close a gas port, preventing further piston movement and so resisting further tube extension.

EP0071406 has a priority date in 1981 and to the best of the knowledge of the applicant the mooring line described in EP0071406 did not achieve commercial success. One of the major practical challenges in this field is longevity. It is believed that the composite rubber and glass fibre tube would have suffered from damage when subject to prolonged cyclical loading, making it unsuited to use in a mooring.

GB2467345 describes a mooring “limb” having an impervious sleeve within an outer braided sleeve depicted to be of tubular form and provided with loops at its ends for attachment to mooring ropes or chains. The impervious sleeve forms a chamber which communicates—in the preferred embodiment—with the surrounding seawater through an orifice. The limb is clearly intended to be submerged, so that the impervious sleeve fills with water at the ambient hydrostatic pressure. The braided sleeve is able to extend (to increase in length) in response to an increase in load applied to it by the mooring ropes and when it does so it suffers a reduction in its diameter. Consequently the braided outer sleeve squeezes the impervious sleeve, reducing its volume and causing exhaustion of water through the orifice, providing a damping effect. It seems that the braided sleeve/impervious sleeve arrangement is incapable of providing a spring-like restoring force when extended. Instead there is to be a “resilient means” whose nature is not explained in the document but which is shown as an elongate rectangular member extending axially through the impervious sleeve. Presumably this must function in the manner of a tension spring to provide the restoring force. Further “resilient means” at intervals along the limb's length appear, from the drawings, to be intended to urge at least the braided sleeve to expand laterally.

The practicality and durability of this combination of a braided sleeve arrangement to provide damping with seemingly mechanical springs to provide a return force is open to question.

Outside of the field of mooring as such there is a need for a robust and reliable form of line or tether for forming a linkage between two structures which is compliant in length and able to provide damping.

The present invention provides, in one aspect, a line and a method according to the appended independent claims.

Lines embodying the invention are able to:
provide compliance, accommodating changes in the separation of the first structure and the second, and reducing the transient loads that could otherwise be created by movement of one of the structures away from the other;
function in the manner of a tensile spring, being extended by tensile loading but providing a restoring force tending to return the line to its unloaded length. The pressurised bladder urges the sheath laterally outwards. The sheath can only expand laterally if at the same time it contracts in length. So the constant pressurisation of the bladder's chamber causes the line to constantly exert a tensile force (unless it contracts to its maximum extent);
provide a damping function (a force related to the speed of extension of the line) by virtue of the dissipation of energy due to passage of the fluid displaced from the bladder's chamber through the restricted passage;
allow for adjustment of both stiffness and damping in a simple manner. The restriction on flow out of the bladder can be varied to adjust damping. Pressure in the bladder can be varied to adjust the ratio of load to extension (i.e. the tensile stiffness)) of the sheath; and
be formed in a simple and robust manner which can be economical and can be sufficiently robust to survive an extended design lifetime in the hostile marine environment.

In the context of a mooring, the line according to the invention provides a robust and simple way to decouple the maximum breaking strain from the axial tension in the mooring lines.

There is a second aspect to the present invention addressed to a different problem, which is how to provide a linear actuator suitable for subsea use which is robust and simple. This problem is addressed by the linear actuator of appended claim 16.

Specific embodiments of the present invention will now be described, by way of example only, with reference to the accompanying drawings, in which:

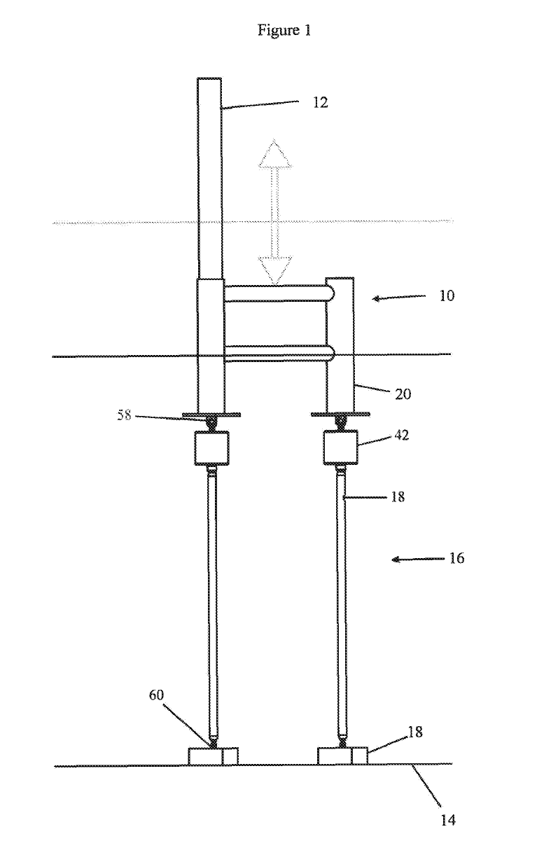

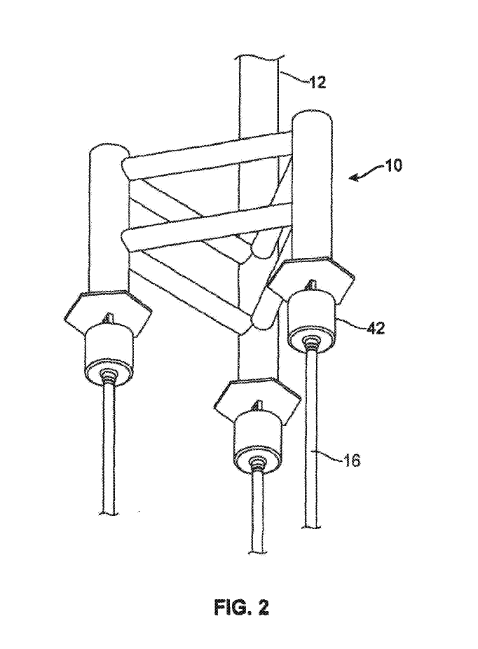

FIGS. 1 and 2 show a wind turbine platform moored using lines embodying the present invention in side elevation and from beneath and to one side, respectively;

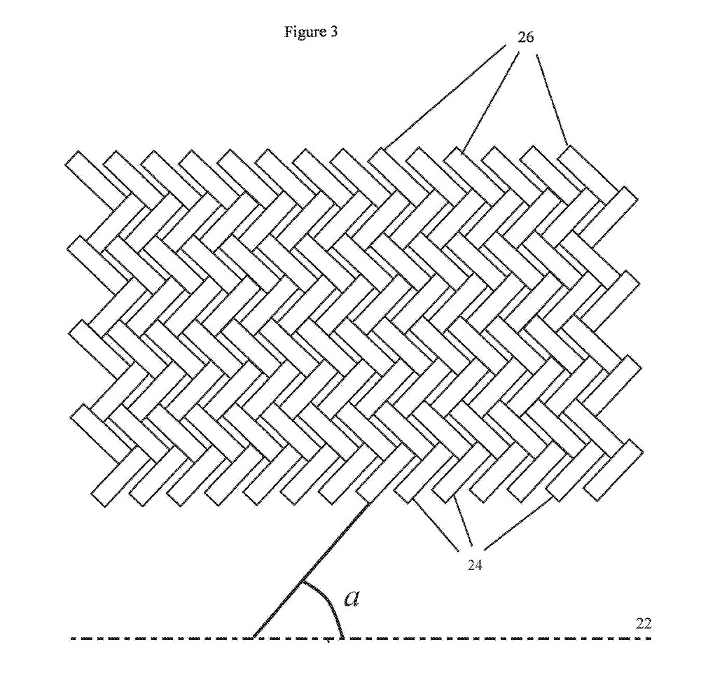

FIG. 3 is a somewhat simplified representation of part of a braided sheath used in the mooring lines;

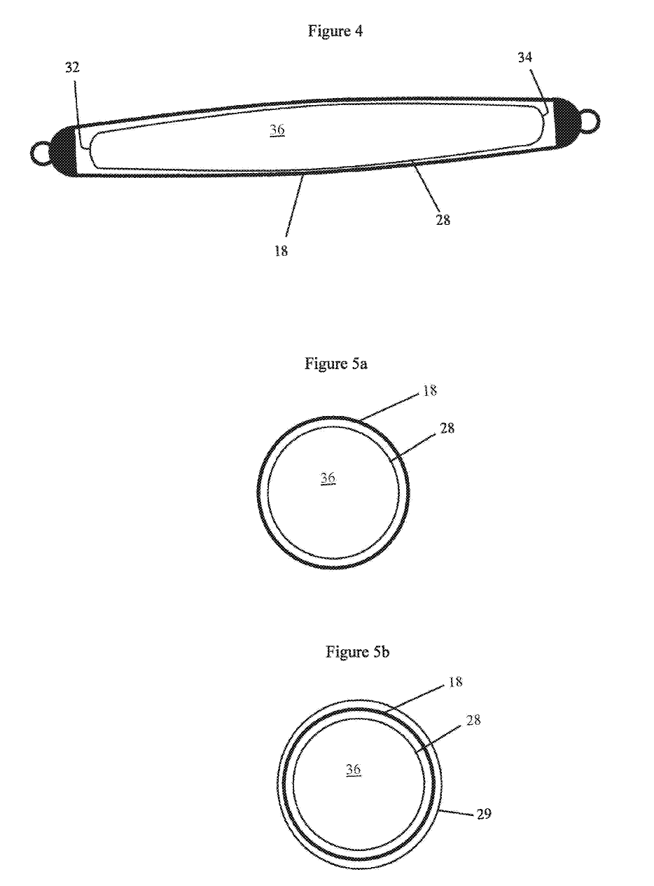

FIGS. 4 and 5a are somewhat schematic sections in axial and radial planes respectively through a mooring line embodying the present invention;

FIG. 5b is a schematic section in an axial plane through a mooring line which is similar to that of FIG. 5a but additionally incorporates an enclosure serving to retain a liquid lubricant;

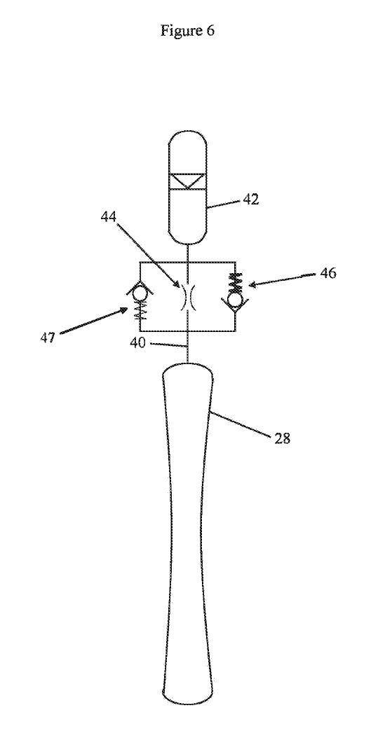

FIG. 6 is a schematic representation of a hydraulic arrangement associated with one of the mooring lines; and

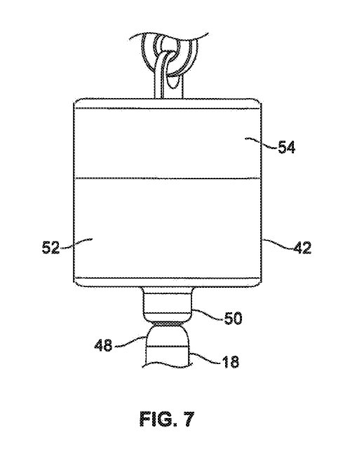

FIG. 7 is a side view of an accumulator arrangement at one end of one of the mooring lines.

FIGS. 1 and 2 show a floating platform 10 which in this example supports a wind turbine. Details of the turbine itself are not relevant for present purposes and are not shown in the drawings beyond an upright column 12 for carrying it. The platform 10 is moored to the sea bed 14 through multiple taut mooring lines 16 running downwardly from the platform 10 to substantial foundations 18 upon the sea bed. In the illustrated example the structure of the platform 10 has three depending legs 20 each provided with a respective mooring line 16. The floating structure may however take any number of different forms in other embodiments and other applications of the present invention—it could for example be part of a wave energy generating device, or indeed a vessel such as a ship.

The mooring lines 16 are formed in accordance with the present invention to provide (a) compliance—i.e. the ability to extend under load, (b) damping—i.e. dissipation of energy, and (c) restoring force—i.e. a force which tends to return the line to a shorter length following extension. The lines are in this example taut and pre-tensioned—that is, they are somewhat extended under normal conditions, and so constantly exert a restraining force on the platform tending to keep it in its position with respect to the sea bed, and in a certain orientation. In this way, under normal conditions, the platform is located and stabilised. But due to the lines' compliance the platform 10 is able to move when necessary, e.g. in heavy seas.

The mooring lines 16 each have a sheath 18 of braided material. This may be described as a woven tube. Braids and braiding are very well known, for example in the manufacture of rope and of fibre reinforcements for moulded composite items, and need not be explained in detail herein, but FIG. 3 shows one suitable form of braided material, by way of illustration only. The drawing shows only a small area of a braided tube. Although the material appears flat in the drawing, which is somewhat simplified, it should be understood that it is curved to form a hollow cylinder. Fibres of the material extend generally helically. That is, they are angled to the longitudinal axis 22 of the braided cylinder. One set of fibres 24 is inclined at an angle α to the axis. Another set of fibres 26 is inclined at an opposite angle −α. The two sets of fibres are woven, passing over and under one another to form the braided structure.

This is only one example of a braid. Other forms of braid are known and may be adopted in embodiments of the present invention.

The fibres making up the braid may be of any suitable type, selected to suit the application in hand. One suitable braided material is sold under the registered trade mark Vectran, which is formed from liquid crystal polymer. Another suitable material is sold under the registered trade mark Dyneema and comprises ultra-high molecular weight polyethylene. There are other high strength polymer fibres and other types of fibre that may be used.

Tension applied to the sheath 18 along its axis tends to reduce the angle α between the fibres 24, 26 and the sheath axis 22. In this way the pitch of the helix formed by the fibres increases, allowing the length of the sheath 18 also to increase. But this increase in pitch and in the sheath's longitudinal dimension is accompanied by a reduction in the sheath's lateral dimension—its diameter. So under tension the sheath becomes longer and thinner. Conversely, if the lateral dimension of the sheath 18 increases then its length decreases. These length changes can happen by virtue of movement of the fibres 24, 26, and are not reliant on stretching of the fibres themselves. Extension of the sheath 18 results in a reduction in its internal volume. Contraction results in an increase of internal volume.

There are limits to the longitudinal expansion and contraction that the sheath 18 can suffer. As it reaches its maximum length the sheath 18 becomes much stiffer with respect to axial loading

Within the sheath 18 is an impermeable bladder 28—see FIGS. 4 and 5. In the present embodiment the bladder 28 has a flexible generally tubular wall 30 having closed ends 32, 34 and forming an internal chamber 36 which is able to be pressurised. The bladder wall is elastically expansible at least in the lateral direction. This may be because the bladder is formed with an elastomeric material. In the present embodiment the bladder wall comprises polyurethane. Natural or synthetic rubber or any other suitable material could be substituted. The chamber 36 is filled with hydraulic fluid, specifically water in the present embodiment.

The bladder 28 is pressurised. That is to say that the pressure inside the bladder 28 is greater than the pressure of its surroundings. Of course in the illustrated example the bladder is deployed underwater and extends vertically, so that the hydrostatic pressure on the bladder increases significantly along the bladder's length, but since the bladder is water filled its internal pressure likewise increases with depth so that the pressure difference between the interior and the exterior of the bladder is substantially constant from top to bottom. The over-pressure within the bladder urges it to increase in its lateral dimension—i.e. its diameter.

The bladder 28 takes up the available space within the sheath 18 and is laterally constrained by it. The bladder 28 may press directly against the sheath 18, but in order to prevent wear an intermediate layer low friction layer may be interposed between the two. Additionally or alternatively a liquid lubricant may be used to reduce friction between the bladder 28 and the sheath 18. This can be achieved by providing an impermeable enclosure 29 around the sheath 18, as shown in FIG. 5a. The space between the enclosure 29 and the bladder 28 contains the lubricant, which may for example comprise liquid silicone.

In the present embodiment the bladder 28 extends and contracts in length along with the sheath 18 but this is not essential—it may remain largely unchanged in length as the sheath about it extends and contracts.

Note that FIGS. 4 and 5 are highly schematic. A separation is shown between the sheath 18 and the bladder 28, but this is merely so that they can be distinguished from one another in the drawings.

The pressurised bladder 28 and the braided sheath 18 together provide the two functions required of a shock absorber—springing and damping.

Because the pressurised bladder tends to increase the lateral dimension of the sheath 18, it also tends to reduce its length. In this way the bladder 28 and the sheath 18 cooperate to provide the aforementioned restoring force. Because the sheath 18 is constantly urged radially outwards by the bladder, it tends at all times (save when it reaches maximum contraction) to contract along its length. In this way the sheath/bladder combination serves in a manner analogous to a spring.

The bladder 28 and sheath 18 together also provide a mechanism for dissipation of energy—i.e. for damping. Extension of the sheath 18 causes a reduction in its internal volume. The bladder 28 is thereby squeezed. A constricted route is provided for exhaustion of fluid from the bladder 28, as will be explained below. An increase in axial load on the sheath 18 causes a pressure increase in the chamber 36, exhausting liquid through the constricted passage. Because of this exhaustion of fluid, the sheath 18 is able to extend axially, but energy is dissipated in displacing the fluid through the constricted passage, providing damping. This is a dynamic effect—the damping force is created in response to movement of the sheath (i.e. a change in its extension). In this respect it is different in kind from the restoring force which is created in response to displacement (extension).

The hydraulic arrangement used to pressurise the bladder 28 and to provide damping is illustrated highly schematically in FIG. 6. This drawing is intended merely to illustrate the principle of operation. Flow passage 40 leads from the bladder 28 to an accumulator 42 serving as a compliant pressure source via a flow restriction 44 of some form. A relief valve 46 is able to open in response to excessive pressure to provide a route for exhaustion of fluid from the bladder 28 which excludes the restriction 44 and so gives a lower resistance route for exhaustion of fluid from the bladder. A one-way filling valve 47 is arranged to open when pressure in the accumulator 42 exceeds pressure in the bladder 28, to provide a low-resistance path for water flow to the bladder to enable it to refill as it contracts. Note that the valves 46 and 47 have different characteristics. The refill valve 47 opens in response to a small pressure difference. The relief valve 46—depicted as being more heavily spring biased toward its closed position in FIG. 6—opens only when pressure in the bladder 28 becomes excessive.

The accumulator 42 is pressurised. Under static conditions there is a balance of pressures in the bladder 28 and the accumulator 42. In normal seas, the platform 10 will rise and fall somewhat (and will also have a periodic lateral motion) so that the sheath 18 will extend and contract and liquid will pass through the flow line 40 and the flow restriction 44, the hydraulics thus exerting the above mentioned damping effect. In heavier seas the pressure difference between the accumulator 42 and the bladder 28 may become large enough to cause the relief valve 46 to open. This permits fluid flow from the bladder to with less resistance so that the movement is more lightly damped, which may be desirable in order to permit rapid platform movement in such conditions.

The flow restriction 44 produces a pressure change in response to flow. When fluid flows, pressure on the upstream side of the flow restriction 44 is greater than pressure on its downstream side. This function can be achieved in various ways, and the flow restriction 44 can be specified to produce a desired damping characteristic. For example it may be a simple orifice. It could be a narrowed passage. It could be formed by a valve.

The accumulator 42 may be partly gas filled. The hydraulic arrangement depicted in FIG. 6 may be sealed. In this case the gas in the accumulator provides the system with compliance, being compressed when the line is extended, thereby storing energy which is returned as the line subsequently contracts.

The characteristics of the system can be straightforwardly adjusted in two ways—(1) varying the pressure and (2) varying the volume of gas in the accumulator (which is done by varying the total volume of water in the system). A change in the pre-pressurisation of the system changes the magnitude of the return force (for a given line extension). In a practical mooring arrangement in which line is under tension and its length is able to change, its effect can therefore be to change the line length. Since the gas 54 in the accumulator contributes compliance, a change in its volume (for a given line extension) produces a change in the rate at which the line tension varies with its extension—i.e. it changes the stiffness of the line. It is straightforward to provide for adjustment of both properties, e.g. by leading gas and water lines from the accumulator to some vessel on the surface.

This is highly advantageous. Suppose for example that a set of mooring lines is to be installed and adjusted to (a) orient a floating structure along a certain direction, and (b) exert a chosen tension on the structure to restrict its motion. This may involve adjustment of line length/tension after their installation. The present invention allows such adjustments to be made in a straightforward manner. After suitable adjustment the hydraulic arrangement can be sealed to maintain the system's settings.

FIG. 6 is purely illustrative. The necessary hydraulic function may be provided by other arrangements, and may be modified in practical embodiments. For example, the relief valve 46 may be dispensed with in certain embodiments. Although it is shown as a one-way valve in the drawing it may be capable of permitting flow in both directions, to allow the bladder 28 to fill rapidly as well as discharging rapidly. The flow restriction 44 may be adjustable, to allow adjustment of the damping rate. It may be an active component, e.g. in that it is able to respond automatically to changing conditions or in that it is under electronic control. The functions of the flow restriction 44 and the relief valve 46 may be performed by a single unit.

The hydraulics can be provided in a compact and robust package. FIG. 7 shows components at the top end of the sheath 18. A ferrule 48 is used to make a secure mechanical linkage to the sheath 18. The flow passage 42 is not seen in this drawing but leads into a governor unit 50 arranged coaxially with the sheath 18 and containing the components used to govern fluid flow. The accumulator 42 is also coaxially arranged with respect to the sheath 18 and forms the coupling through which the sheath 18 is attached to the platform 10. In the example the accumulator is a pressure vessel containing the hydraulic fluid 52 and above it a body of gas 54, which may be air.

Note that in this embodiment it is the sheath 18 alone that carries loads applied to the line 16. The sheath 18 is provided with couplings to enable it to be secured to the floating structure and the seabed foundations 18. In the present embodiment these take the form of simple rings 58, 60 at opposite ends of the sheath 18 (see FIG. 1). Although the sheath 18 makes up almost the entire length of the mooring line 16 in the illustrated embodiment this need not always be the case—the mooring may additionally incorporate rope or chain. It could for example take the form of a catenary mooring.

The arrangement has various advantages not yet referred to. One possible mode of failure is depressurisation of the bladder 28, e.g. because it develops a puncture. In that case the sheath 18 remains able to support a large tension because—at least in the preferred embodiments described herein—it is akin to a large rope. Hence catastrophic failure can be avoided at least for a time, giving an opportunity for remedial work. Also modelling demonstrates that the restoring force exerted by the arrangement does not vary linearly with extension but instead is greater at large extensions. The sheath becomes progressively stiffer as it approaches its maximum length. This is a desirable characteristic in the context, where moderate forces are needed to control platform motion under normal conditions but large force may be needed to retain platform position in high seas.

Lines embodying the present invention may be used in any of a wide range of applications in which one structure needs to be compliantly tethered to another. These are not limited to underwater applications.

1. An elongate, flexible line for providing a linkage between a first structure and a second structure, the line comprising:
an elongate tubular sheath of braided material, the sheath being able to change reversibly and repeatedly in length and its braided structure being such that an increase in length of the sheath is accompanied by a decrease in its lateral dimension;
an impervious flexible bladder within the sheath, the bladder defining a fluid-containing internal chamber which is acted on by the sheath so that the volume of the chamber varies with the length of the sheath;
a pressure source arranged to pressurise the chamber; and
a passage communicating with the chamber and incorporating a restriction;
so that in operation
the pressurised bladder urges the sheath to expand laterally and so to contract in length; and
an increase in length of the sheath causes fluid to be exhausted from the chamber through the restriction, increasing chamber pressure and providing a damping force opposed to the increase in the sheath's length.

2. The line as claimed in claim 1 in which first and second couplings are attached to the sheath, being spaced from one another along the sheath's length, and are configured to be coupled respectively to the first and second structures.

3. The line as claimed in claim 1 in which the restriction comprises an orifice.

4. The line as claimed in claim 1 which further comprises a relief valve arranged to open in response to excess pressure across the restriction.

5. The line as claimed in claim 4 which further comprises a one-way refill valve arranged to permit fluid to flow into the bladder without passing through the orifice.

6. The line as claimed in claim 1 in which the said passage leads via the restriction to the pressure source.

7. The line as claimed in claim 1 in which the pressure source is a pressurised accumulator.

8. The line as claimed in claim 1 which is a mooring line.

9. The line as claimed in claim 8 in which the pressure source comprises an accumulator.

10. The line as claimed in claim 9 in which the accumulator is partly gas-filled, so that gas in the accumulator is compressed as the line extends and expands as the line contracts.

11. The floating structure moored by a line as claimed in claim 7.

12. A method of tethering a first structure to a second structure, the method comprising:
providing an elongate tubular sheath of braided material, the sheath having two ends and being able to change reversibly and repeatedly in length and its braided structure being such that an increase in length of the sheath is accompanied by a decrease in its lateral dimension;
coupling one end of the sheath to the first structure and the other end of the sheath to the second structure;
providing an impervious flexible bladder within the sheath, the bladder defining a fluid-containing internal chamber which is acted on by the sheath so that the volume of the chamber varies with the length of the sheath;
connecting a pressure source to the bladder to pressurise the chamber; and
providing a passage communicating with the chamber and incorporating a restriction;
so that in operation
the pressurised bladder urges the sheath to expand laterally and so to contract in length; and
an increase in length of the sheath causes fluid to be exhausted from the chamber through the restriction, increasing chamber pressure and providing a damping force opposed to the increase in the sheath's length.

13. The method as claimed in claim 12 which is a method of mooring, the first structure being a floating structure.

14. The method as claimed in claim 12 comprising adjusting length and/or tension of the sheath by varying pressure within the impervious flexible bladder.

15. The method as claimed in claim 12 in which the pressure source is an accumulator containing gas and the method further comprises adjusting the sheath's stiffness by adjusting volume of gas in the accumulator.

16. A submersible linear actuator comprising:
an elongate tubular sheath of braided material, the sheath being able to change reversibly and repeatedly in length and its braided structure being such that an increase in length of the sheath is accompanied by a decrease in its lateral dimension;
an impervious flexible bladder within the sheath, the bladder defining a fluid-containing internal chamber which is acted on by the sheath so that the volume of the chamber varies with the length of the sheath; and
a pressure source connectable to the chamber to enable controlled variation of pressure in the bladder and thereby to vary length of the sheath.

17. The submersible linear actuator as claimed in claim 16 which is in the form of a flexible line for providing a linkage between a first structure and a second structure.

18. The submersible linear actuator as claimed in claim 17 which forms or is incorporated in a mooring line for a floating structure.
